(19) United States
(12) Patent Application Publication
(10) Pub. No.: US 2013/0124699 A1
(43) Pub. Date: May 16, 2013

(54) APPARATUS AND METHOD FOR TRANSCEIVING A STREAMING SERVICE

(71) Applicants: Soon Heung Jung, Daejeon (KR); Kwang Deok Seo, Wonju-si Gangwon-do (KR); Jin Young Lee, Daejeon (KR); Seong Jun Bae, Daejeon (KR); Jung Won Kang, Daejeon (KR); Sang Woo Shim, Wonju-si Gangwon-do (KR); Truong Cong Thang, Daejeon (KR); Sang Taick Park, Daejeon (KR); Won Ryu, Daejeon (KR)

(72) Inventors: Soon Heung Jung, Daejeon (KR); Kwang Deok Seo, Wonju-si Gangwon-do (KR); Jin Young Lee, Daejeon (KR); Seong Jun Bae, Daejeon (KR); Jung Won Kang, Daejeon (KR); Sang Woo Shim, Wonju-si Gangwon-do (KR); Truong Cong Thang, Daejeon (KR); Sang Taick Park, Daejeon (KR); Won Ryu, Daejeon (KR)

(73) Assignee: Electronics and Telecommunications Research Instititute, Daejeon (KR)

(21) Appl. No.: 13/810,600

(22) PCT Filed: Jul. 15, 2011
(86) PCT No.: PCT/KR2011/005221

§ 371 Date: Jan. 16, 2013

Related U.S. Application Data
(60) Provisional application No. 61/365,163, filed on Jul. 16, 2010.
(60) Provisional application No. 61/365,849, filed on Jul. 20, 2010.

(30) Foreign Application Priority Data
Apr. 4, 2011 (KR) 10-2011-0030807

(51) Int. Cl. H04L 29/06

(52) U.S. Cl. CPC H04L 65/608
USPC 709/219

(57) ABSTRACT

Provided is an apparatus and method for transmitting and receiving a streaming service. The apparatus and method for transmitting and receiving a streaming service may use a light multimedia file suitable for a Hypertext Transfer Protocol (HTTP) streaming service. Using an HTTP hint track, an International Organization for Standardization (ISO) file generated in a non-interleaved storing scheme that is unsuitable for an HTTP streaming service may be converted into an ISO file based on an interleaved storing scheme that is suitable for an HTTP streaming service. An ISO file may include multiple media tracks for supporting multiple bitrates and resolutions. Chunk data of media tracks that provide multiple multimedia qualities may be effectively acquired, and a light ISO file suitable for an HTTP streaming service may be generated by storing the acquired chunk data in an interleaved scheme.

### TECHNICAL FIELD

The present invention relates to an apparatus and method for transmitting and receiving a streaming service, and more particularly, to an apparatus and method for transmitting and receiving a Hypertext Transfer Protocol (HTTP) streaming service.

### BACKGROUND ART

In a Hypertext Transfer Protocol (HTTP) streaming service, a terminal may use an HTTP to request a download of a content file. A server may use a transmission control protocol (TCP) to respond to the request and deliver the requested content file to the terminal.

A content file may use an International Organization for Standardization (ISO) based media file format.

A content file using the ISO based media file format may include multiple media tracks to support multiple bitrates and resolutions.

A content file using the ISO based media file format and including multiple media tracks may use an HTTP hint track.

An HTTP streaming service utilizing a hint track of a content file may reduce a size of a transmitted content file. Reducing of a size of a content file may lead to a reduction of a download time of a file and a reduction of an amount of traffic in an internet protocol (IP) based network such as the Internet.

Accordingly, a terminal and a server may effectively provide a quality adaptive HTTP streaming service by utilizing an HTTP hint track.

### DISCLOSURE OF INVENTION

### Technical Goals

An aspect of the present invention provides an apparatus and method for converting an International Organization for Standardization (ISO) file generated based on a non-interleaved storing scheme into an ISO file based on an interleaved storing scheme that is effective for a Hypertext Transfer Protocol (HTTP) streaming service.

Another aspect of the present invention provides an apparatus and method for providing a quality adaptive HTTP streaming service for an ISO file including multiple media tracks to support multiple bitrates and resolutions.

### Technical Solutions

According to an aspect of the present invention, there is provided a method of transmitting a streaming service, the method including receiving, from a terminal, a request for a first light International Organization for Standardization (ISO) file, generating the first light ISO file based on an original file, and transmitting, to the terminal, the first light ISO file through a stream, wherein the first light ISO file includes at least one first video chunk and at least one first audio chunk, and the at least one first video chunk and at least one first audio chunk included in the first light ISO file are interleaved.

The request for the first light ISO file may include first quality information of the first light ISO file. The at least one first video chunk may refer to chunks of videos corresponding to the first quality information, and the at least one first audio chunk may refer to chunks of audio corresponding to the first quality information.

The generating may include identifying an n^{th} first video chunk among the at least one first video chunk and an n^{th} first audio chunk among the at least one first audio chunk, the at least one first video chunk and the at least one first audio chunk being pointed to by an n^{th} first Hypertext Transfer Protocol (HTTP) chunk pointer among first HTTP chunk pointers included in the original file, and n being greater than or equal to 1 and less than or equal to a number of the at least one first video chunk, determining the n^{th} first video chunk and the n^{th} first audio chunk as chunks to be included in an n^{th} first HTTP chunk among first HTTP chunks, and generating a first light ISO file that successively includes the first HTTP chunk, the at least one first video chunk and the at least one first audio chunk being successively arranged in the first light ISO file in an interleaved scheme.

The generating may further include calculating an n^{th} chunk offset that indicates a position of the n^{th} first HTTP chunk in the first light ISO file, wherein the generating includes arranging the n^{th} first HTTP chunk in the first light ISO file using the n^{th} chunk offset.

The method may further include receiving, from the terminal, a request for a second light ISO file, generating the second light ISO file based on the original file, and transmitting, to the terminal, the second light ISO file through a stream, wherein the second light ISO file includes at least one second video chunk and at least one second audio chunk, and the at least one second video chunk and at least one second audio chunk included in the second light ISO file are interleaved.

The at least one second video chunk may refer to video chunks corresponding to non-transmitted first video chunks that are not transmitted to the terminal by a streaming service of the first light ISO file among the at least one first video chunk when the request for the second light ISO file is received, and the at least one second audio chunk may refer to audio chunks corresponding to non-transmitted first audio chunks that are not transmitted to the terminal by a streaming service of the first light ISO file among the at least one first audio chunk when the request for the second light ISO file is received.

The request for the first light ISO file may include first quality information of the first light ISO file, the request for the second light ISO file may include second quality information of the second light ISO file, the at least one first video chunk may refer to chunks of videos corresponding to the first quality information, the at least one second video may refer to chunks of videos corresponding to the second quality information, the at least one first audio chunk may refer to chunks of audio corresponding to the first quality information, and the at least one second audio chunk may refer to chunks of audio corresponding to the second quality information.

The at least one video chunk and the at least one second video chunk may correspond to chunks of videos having the same content and having different qualities.

The generating of the second light ISO file may include identifying an n^{th} second video chunk among the at least one second video chunk and an n^{th} second audio chunk among the at least one second audio chunk, the at least one second video chunk and the at least one second audio chunk being pointed to by an n^{th} second HTTP chunk pointer among second HTTP chunk pointers included in the original file, n being greater than or equal to m and less than or equal to a number of the at least one second video chunk, and m corresponding to an index of a primary first video chunk that is not transmitted to the terminal by a streaming service among the at least one first video chunk in the first light ISO file when the request for the second light ISO file is received, determining the n^{th} second video chunk and the n^{th} second audio chunk as chunks to be included in an n^{th} second HTTP chunk among second HTTP chunks, and generating the second light ISO file that successively includes the second HTTP chunks, the at least one second video chunk and the at least one second audio chunk being successively arranged in the second light ISO file in an interleaved scheme.

According to another aspect of the present invention, there is provided an apparatus for transmitting a streaming service, the apparatus including a receiver to receive, from a terminal, a request for a first light ISO file, a light ISO file generator to generate the first light ISO file based on an original file, and a transmitter to transmit, to the terminal, the first light ISO file through a stream, wherein the light ISO file generator includes, in the first light ISO file, at least one first video chunk and at least one first audio chunk to be interleaved.

According to still another aspect of the present invention, there is provided a method of receiving a streaming service, the method including transmitting, to a server, a request for a first light ISO file, receiving, from the server, the first light ISO file generated based on an original file through a stream, transmitting, to the server, a request for a second light ISO file, and receiving, from the server, the second light ISO file generated based on the original file through a stream, wherein the first light ISO file includes at least one first video chunk and at least one first audio chunk, the second light ISO file includes at least one second video chunk and at least one second audio chunk, the at least one first video chunk and at least one first audio chunk included in the first light ISO file are interleaved, and the at least one second video chunk and at least one second audio chunk included in the second light ISO file are interleaved.

The method may further include generating first quality information indicating a quality of the first light ISO file, and generating second quality information indicating a quality of the second light ISO file, wherein the request for the first light ISO file includes the first quality information, the request for the second light ISO file includes the second quality information, the at least one first video chunk refers to chunks of videos corresponding to the first quality information, the at least one second video chunk refers to chunks of videos corresponding to the second quality information, the at least one first audio chunk refers to chunks of audios corresponding to the first quality information, and the at least one second audio chunk refers to chunks of audios corresponding to the second quality information.

According to yet another aspect of the present invention, there is provided an apparatus for receiving a streaming service, the apparatus including transmitting, to a server, a request for a first light ISO file, receiving, from the server, the first light ISO file generated based on an original file through a stream, transmitting, to the server, a request for a second light ISO file, and receiving, from the server, the second light ISO file generated based on the original file through a stream, wherein the first light ISO file includes at least one first video chunk and at least one first audio chunk, the second light ISO file includes at least one second video chunk and at least one second audio chunk, the at least one first video chunk and at least one first audio chunk included in the first light ISO file are interleaved, and the at least one second video chunk and at least one second audio chunk included in the second light ISO file are interleaved.

The apparatus may further include generating first quality information indicating a quality of the first light ISO file, and generating second quality information indicating a quality of the second light ISO file, wherein the request for the first light ISO file includes the first quality information, the request for the second light ISO file includes the second quality information, the at least one first video chunk refers to chunks of videos corresponding to the first quality information, the at least one second video chunk refers to chunks of videos corresponding to the second quality information, the at least one first audio chunk refers to chunks of audio corresponding to the first quality information, and the at least one second audio chunk refers to chunks of audio corresponding to the second quality information.

According to a further aspect of the present invention, there is provided a method of generating a multimedia file for a streaming service using an original file that includes at least one first video chunk, at least one first audio chunk, and at least one first HTTP chunk pointer, the method including identifying an n^{th} first video chunk among the at least one first video chunk and an n^{th} first audio chunk among the at least one first audio chunk, the at least one first video chunk and the at least one first audio chunk being pointed to by an n^{th} first HTTP chunk pointer among the at least one first HTTP chunk pointer, and n being greater than or equal to 1 and less than or equal to a number of the at least one first video chunk, determining the n^{th} first video chunk and the n^{th} first audio chunk as chunks to be included in an n^{th} first HTTP chunk among first HTTP chunks, and generating a first light ISO file that successively includes the first HTTP chunks, the at least one first video chunk and the at least one first audio chunk being successively arranged in the first light ISO file in an interleaved scheme.

The method may further include calculating an n^{th} first chunk offset that indicates a position of the n^{th} first HTTP chunk in the first light ISO file, wherein the generating includes arranging the n^{th} first HTTP chunk in the first light ISO file using the n^{th} first chunk offset.

The method may further include removing the at least one first HTTP chunk pointer from the original file, wherein the first light ISO file is generated by modifying the original file.

The first light ISO file may include a ‘moov’ box and an ‘mdat’ box, the ‘mdat’ box may include the first HTTP chunks, the ‘moov’ box may include a first video track and a first audio track, and the first video track and the first audio track may refer to the first HTTP chunks.

The original file may include a ‘moov’ box and an ‘mdat’ box, the ‘mdat’ box may include the at least one first video chunk and the at least one first audio chunk, the ‘moov’ box may include a first video track, a first audio track, and a first HTTP hint track, the first video track may refer to the at least one first video chunk, the first audio track may refer to the at least one first audio chunk, and the first HTTP hint track may refer to chunk offsets.

The original file may include at least one second video chunk, a first video indicated by the at least one first video chunk and a second video indicated by the at least one second video chunk may have different qualities, and the first video may have a quality corresponding to a quality requested for the first light ISO file.

The method may further include removing the at least one second video chunk from the original file, wherein the first light ISO file is generated by modifying the original file.

The method may further include identifying an n^{th} second video chunk among the at least one second video chunk and an n^{th} second audio chunk among the at least one second audio chunk, the at least one second video chunk and the at least one second audio chunk being pointed to by an n^{th} second HTTP chunk pointer among second HTTP chunk pointers, and n being greater than or equal to 1 and less than or equal to a number of the at least one first video chunk, determining the n^{th} second video chunk and the n^{th} second audio chunk as chunks to be included in an n^{th} second HTTP chunk among second HTTP chunks, and generating the second light ISO file that successively includes the second HTTP chunks, the at least one second video chunk and the at least one second audio chunk being successively arranged in the second light ISO file in an interleaved scheme, wherein the original file includes the second HTTP chunk pointers.

According to a further aspect of the present invention, there is provided an apparatus for generating a multimedia file for a streaming service using an original file that includes at least one first video chunk, at least one first audio chunk, and at least one first HTTP chunk pointer, the method including an HTTP chunk identifier to identify an n^{th} first video chunk among the at least one first video chunk and an n^{th} first audio chunk among the at least one first audio chunk, the at least one first video chunk and the at least one first audio chunk being pointed to by an n^{th} first HTTP chunk pointer among the at least one first HTTP chunk pointer, and n being greater than or equal to 1 and less than or equal to a number of the at least one first video chunk, an HTTP chunk determining unit to determine the n^{th} first video chunk and the n^{th} first audio chunk as chunks to be included in an n^{th} first HTTP chunk among first HTTP chunks, and a file generator to generate a first light ISO file that successively includes the first HTTP chunks, wherein the file generator successively arranges the at least one first video chunk and the at least one first audio chunk in the first light ISO file in an interleaved scheme.

### Effect of the Invention

According to an embodiment of the present invention, it is possible to provide an apparatus and method for converting an International Organization for Standardization (ISO) file generated based on a non-interleaved storing scheme into an ISO file based on an interleaved storing scheme that is effective for a Hypertext Transfer Protocol (HTTP) streaming service.

According to another embodiment of the present invention, it is possible to provide an apparatus and method for providing a quality adaptive HTTP streaming service for an ISO file including multiple media tracks to support multiple bitrates and resolutions.

### BRIEF DESCRIPTION OF DRAWINGS

FIG. 1 is a diagram describing a progressive streaming service based on a Hypertext Transfer Protocol (HTTP) according to an embodiment of the present invention.

FIG. 2 is a diagram illustrating a basic structure of an International Organization for Standardization (ISO) based media file format according to an embodiment of the present invention.

FIG. 3 is a diagram illustrating an ISO file format stored in a non-interleaved scheme according to an embodiment of the present invention.

FIG. 4 is a diagram illustrating an ISO file format stored in an interleaved scheme according to an embodiment of the present invention.

FIG. 5 is a flowchart illustrating a process of converting an ISO file and a process of providing HTTP streaming for the converted ISO file according to an embodiment of the present invention.

FIG. 6 is a flowchart illustrating a process of generating a quality adaptive ISO file using HTTP hint track switching and a process of HTTP streaming for the generated ISO file according to an embodiment of the present invention.

FIG. 7 is a diagram illustrating a scheme of converting an ISO file based on a non-interleaved storing scheme to an ISO file based on an interleaved storing scheme using an HTTP hint track according to an embodiment of the present invention.

FIG. 8 is a diagram illustrating a scheme of generating a ‘moov’ through a transcoding process that includes deleting an HTTP hint track and changing a chunk offset value according to an embodiment of the present invention.

FIG. 9 is a diagram illustrating a scheme of converting an ISO file based on a non-interleaved storing scheme into an ISO file based on an interleaved storing scheme using multiple HTTP hint tracks according to an embodiment of the present invention.

FIG. 10 is a diagram illustrating a scheme of generating a plurality of ‘moov’s through a transcoding process for an original file that includes multiple HTTP hint tracks according to an embodiment of the present invention.

FIG. 11 is a diagram illustrating a scheme of converting an ISO file based on an interleaved storing scheme into a light ISO file based on an interleaved storing scheme using multiple HTTP hint tracks according to an embodiment of the present invention.

FIG. 12 is a flowchart illustrating a scheme of generating a light ISO file based on an interleaved storing scheme according to an embodiment of the present invention.

FIG. 13 is a diagram illustrating a scheme of generating an interleaved ISO file for a quality adaptive HTTP streaming service according to an embodiment of the present invention.

FIG. 14 is a flowchart illustrating a method for a quality adaptive HTTP streaming service according to an embodiment of the present invention.

FIG. 15 is a diagram illustrating a configuration of a server according to an embodiment of the present invention.

FIG. 16 is a diagram illustrating a sample description box according to an embodiment of the present invention.

FIG. 17 is a diagram illustrating additional data according to an embodiment of the present invention.

FIG. 18 is a diagram illustrating a sample format in an HTTP hint track according to an embodiment of the present invention.

FIG. 19 is a diagram illustrating a packet entry format according to an embodiment of the present invention.

FIG. 20 is a diagram illustrating a constructor format according to an embodiment of the present invention.

### BEST MODE FOR CARRYING OUT THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

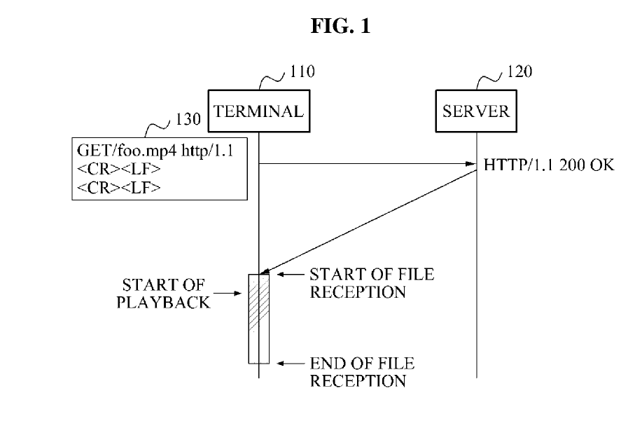

FIG. 1 is a diagram describing a progressive streaming service based on a Hypertext Transfer Protocol (HTTP) according to an embodiment of the present invention.

A terminal, that is, a client 110 may transmit, a “Get Request” 130 in an HTTP stream to inform a server 120 about a request for a service related to a desired content file.

The server 120 may transmit a content file to the terminal 110. The server 120 may use a transmission control protocol (TCP) as a transmission protocol for transmitting the content file.

The content file may arrive at the terminal 110 by the TCP.

The terminal 110 may buffer a portion of data in the content file that initially arrives.

The terminal 110 may play back video and audio files by parsing the buffered portion of data in the content file.

Thus, an HTTP streaming service may be distinguished from a download scheme in which a content file is played back after all data in the content file arrives at the terminal 110. The HTTP streaming service may reduce a service latency time which may be an issue in a conventional download scheme.

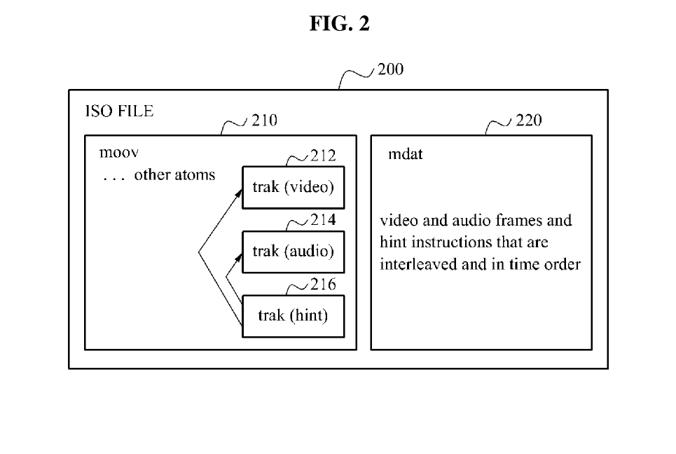

FIG. 2 is a diagram illustrating a basic structure of an International Organization for Standardization (ISO) based media file format according to an embodiment of the present invention.

A content file transmitted in an HTTP streaming service may be generated based on various multimedia file format standards such as QuickTime (.mov), Moving Picture Experts Group (MPEG)-4 (.mp4), Windows Media Video (.wmv), Flash Video (.flv), 3^{rd} Generation Partnership Project (3GPP) (.3gp), and the like to store compressed video and audio files as a single file.

The various multimedia file format standards have been expanded based on ISO/International Electro-technical Commission (IEC) 14496-12 (MPEG-4 part 12) corresponding to a basic multimedia file format standard developed by ISO/IEC MPEG.

Thus, a multimedia file generated based on the various multimedia file format standards has been generated, distributed, and circulated through an Internet protocol (IP) network by the HTTP streaming service.

A format of an ISO file 200 may include a ‘moov’ box (or ‘moov’) 210 and an ‘mdat’ box (or ‘mdat’) 220.

The moov 210 may basically include metadata used for expressing content of a media such as an audio, a video, and data. The mdat 220 may store sample data of a substantial media.

A “trak (video)” 212 may correspond to a video track present in the moov 210. The trak (video) 212 may be a trak box including metadata for expressing content of video sample data stored in the mdat 220.

A “trak (audio)” 214 may correspond to an audio track present in the moov 210. The trak (audio) 214 may be a trak box including metadata for expressing content of audio sample data stored in the the moov 210.

A “trak (hint)” 216 may correspond to a hint track present in the moov 210.

The hint track may be a trak box including instruction information. The instruction information may correspond to information for helping a server access a video track or an audio track and form a data format conforming to a transmission protocol standard to transmit sample data included in the mdat 220.

As a hint track defined according to a standard of an ISO file format, a real-time transport protocol (RTP) hint track and a file delivery (FD) hint track may be given.

The RTP hint track may correspond to a hint track for an RTP that supports real-time streaming The FD hint track may correspond to a hint track for a file delivery over unidirectional transport (FLUTE) protocol that supports a transmission of a forward error correction (FEC) symbol for transmitting fault-tolerant data.

Sample data of a video and audio may be stored in the mdat 220. A storing scheme used in the mdat 220 may include an interleaved scheme and a non-interleaved scheme.

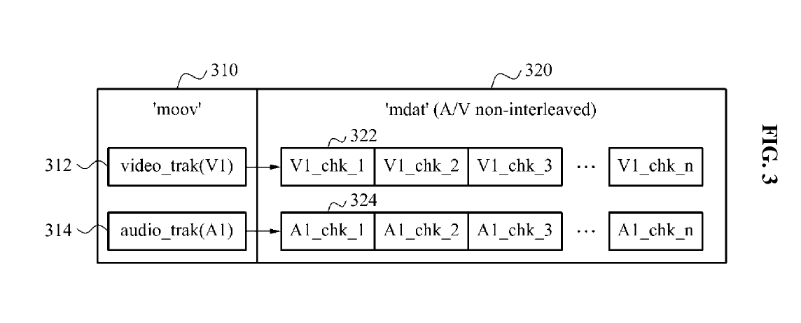

FIG. 3 is a diagram illustrating an ISO file format stored in a non-interleaved scheme according to an embodiment of the present invention.

The non-interleaved scheme may arrange audio and video (A/V) chunks of each media individually.

Referring to FIG. 3, sample data of a video V1 and sample data of an audio A1 stored in the ISO file format may be divided into n chunks (chk_1 through chk_n) 322 or 324, respectively.

The chunks 322 of the video V1 may correspond to V1_chk_1 through V1_chk_1.

The chunks 324 of the audio A1 may correspond to A1_chk_1 through A1_chk_1.

The divided chunks 322 and 324 may be arranged in an ‘mdat’ 320 in the non-interleaved scheme, respectively.

A video_trak (V1) 312 in a ‘moov’ 310 may refer to a first chunk V1_chk_1 in the ‘mdat’ 320.

An audio_trak (A1) 314 in the ‘moov’ 310 may refer to a first chunk A1_chk_1 in the ‘mdat’ 320.

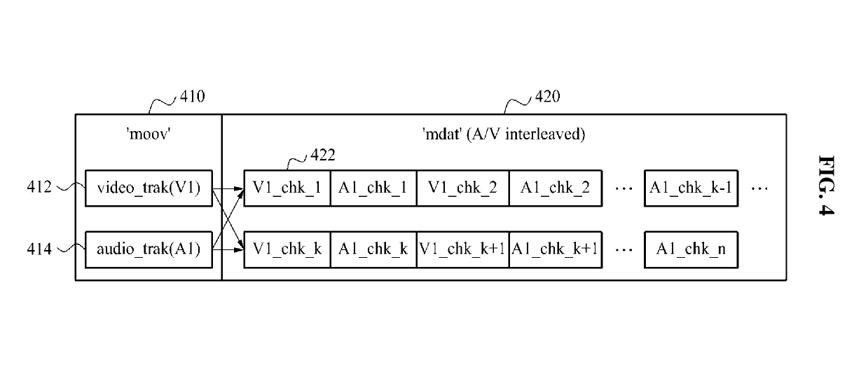

FIG. 4 is a diagram illustrating an ISO file format stored in an interleaved scheme according to an embodiment of the present invention.

The interleaved scheme may mix A/V chunks to be arranged.

Referring to FIG. 4, data samples of a video V1 and an audio A1 stored in the ISO file format may be divided into n chunks (chk_1 through chk_n), respectively.

The chunks 422 of the video V1 may correspond to V1_chk_1 through V1_chk_1.

The chunks 424 of the audio Al may correspond to A1_chk_1 through A1_chk_1.

The divided chunks 422 may be arranged in an ‘mdat’ 420 in the interleaved scheme. That is, a first chunk V1_chk_1 of the video V1 may be followed by a first chunk A1_chk_1 of the audio A1, and the first chunk A1_chk_1 of the audio A1 may be followed by a second chunk V1_chk_1 of the video V1.

A video_trak (V1) 412 in a ‘moov’ 410 and an audio_trak (A1) 314 in the ‘moov’ 410 may refer to a first chunk V1_chk_1 in the ‘mdat’ 320.

When the video_trak (V1) 412 in the ‘moov’ 410 and the audio_trak (A1) 314 in the ‘moov’ 410 only refer to a first chunk V1_chk_1 of the video V1, an excessive calculation may be required to refer to the following chunks. The video_trak (V1) 412 in the ‘moov’ 410 and the audio_trak (A1) 314 in the ‘moov’ 410 may refer to a chunk in the middle of interleaved chunks, for example, a k^{th} chunk V1_chk_k of the video V1, respectively.

A non-interleaved scheme may generate video sample data and audio sample data through a process of individually encoding data, and store the generated video sample data and audio sample data in an ‘mdat’. Thus, the non-interleaved scheme may significantly reduce encoding complexity and cost, thereby easily producing an ISO file, that is, a content file using an ISO based media file format.

Video sample data and audio sample data may be extracted afterwards from an ISO file produced using a non-interleaved storing scheme, and the extracted video sample data and audio sample data may be reused.

Video sample data and audio sample data individually generated and stored in an ISO file format may provide a data structure suitable for a real-time streaming service over RTP since an RTP session for transmitting a video and an RTP session for transmitting an audio are individually formed in the real-time streaming service over RTP. That is, an RTP packet of each of RTP sessions independent from each other may be generated, by individually and straightforwardly extracting sample data from the ‘mdat’ without interference from media tracks different one another.

When an ISO file is generated using a non-interleaved storing scheme, a process of editing the ISO file after generating a file format may be simplified. That is, when the ISO file is edited as necessary after generating a file format, a video and an audio may individually edited. An additional track may be appended to the ISO file by successively storing additional chunks in the ‘mdat’ following original chunks.

However, an interleaved storing scheme may mix related video and audio sample data in chronological order for storage. Thus, using the interleaved storing scheme may increase cost and complexity regarding coding and storing, and increase RTP packet generation complexity for a real-time streaming service over RTP.

The interleaved storing scheme may generate an ISO file by mixing video chunks and audio chunks to be arranged, leading to an increase of editing complexity.

Thus, most ISO files may be generated based on a file format using a non-interleaved scheme. A large number of files generated in the past conventional files may use the non-interleaved scheme.

The HTTP streaming service may transmit file data in an order of being stored based on a file download principle. Thus, ‘moov’ in a file may be transmitted prior to chunks stored in the ‘mdat’ that are transmitted in an order of being stored in the ‘mdat’.

When the non-interleaved storing scheme of FIG. 3 is used, a first audio chunk A1_chk_1 may be transmitted after a transmission of n video chunks V1_chk_1 through V1_chk_n is completed.

Thus, when a file using the non-interleaved storing scheme is transmitted, a starting time of a playback in the terminal of FIG. 1 may be delayed after a relatively long period of time taking for audio chunks synchronized with video chunks to arrive.

The delay of the starting time of a playback may be a main cause that degrades quality content of a service for consumers requesting an HTTP streaming service.

Accordingly, to enhance the quality of an HTTP streaming service, an ISO file may be generated based on the interleaved storing scheme described with reference to FIG. 4, or an ISO file generated based on the non-interleaved storing scheme may be converted to a file format based on the interleaved storing scheme when the ISO file is transmitted.

A scheme may be used to provide an effective HTTP streaming service for an ISO file generated based on the non-interleaved storing scheme.

Embodiments of the present invention yet to be described may disclose an HTTP hint track for effectively providing an HTTP streaming service.

By utilizing the HTTP hint track, an ISO file generated based on the non-interleaved storing scheme which is unsuitable for the HTTP streaming service may be easily converted into a file based on the interleaved storing scheme which is suitable for the HTTP streaming service.

The HTTP hint track may be inserted into an ISO file that is newly generated by an authoring tool. The HTTP hint track may be newly added in a conventional ISO file by a hinting tool without changing a conventional ISO file structure.

Embodiments of the present invention yet to be described may disclose an HTTP hint track switching scheme to support an ISO file including multiple media tracks.

By utilizing HTTP hint track switching, a quality adaptive HTTP streaming service may be effectively provided. An HTTP streaming service utilizing the HTTP hint track may reduce a size of a transmitted content file to reduce a download time of an ISO file and to reduce an amount of traffic in an IP network.

In embodiments of the present invention yet to be described, when an HTTP hint track is inserted into an ISO file generated to be used for an HTTP stream, the HTTP hint track may be individually stored without modifying media tracks stored in the file.

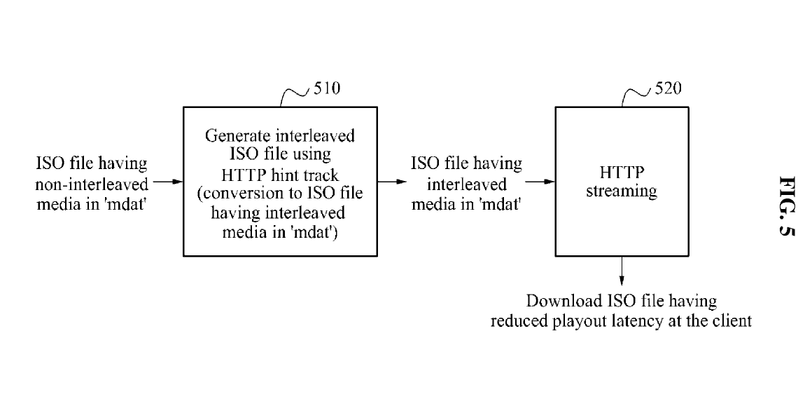

FIG. 5 is a block diagram illustrating a process of converting an ISO file and a process of providing an HTTP stream for the converted ISO file according to an embodiment of the present invention.

A file to be converted may correspond to an ISO file having a non-interleaved media, that is, a video, an audio, and the like in an ‘mdat’.

In operation 510, an ISO file interleaved using an HTTP hint track may be generated. Or, an ISO file having a non-interleaved media in the mdat may be converted into an ISO file having an interleaved media in the mdat.

The converted file may correspond to an ISO file having an interleaved media in the mdat.

In operation 520, an HTTP streaming service for the ISO file having an interleaved media in the mdat may be provided.

Operation 520 may provide an ISO file download having a reduced playout latency in a client, that is, a terminal. That is, a start of a playback at the terminal that receives an ISO file through a download may be reduced.

Embodiments of the present invention described with reference to FIG. 1 through FIG. 4 and technological content according to the embodiments may be applied to the present embodiment. Thus, further descriptions will be omitted for conciseness.

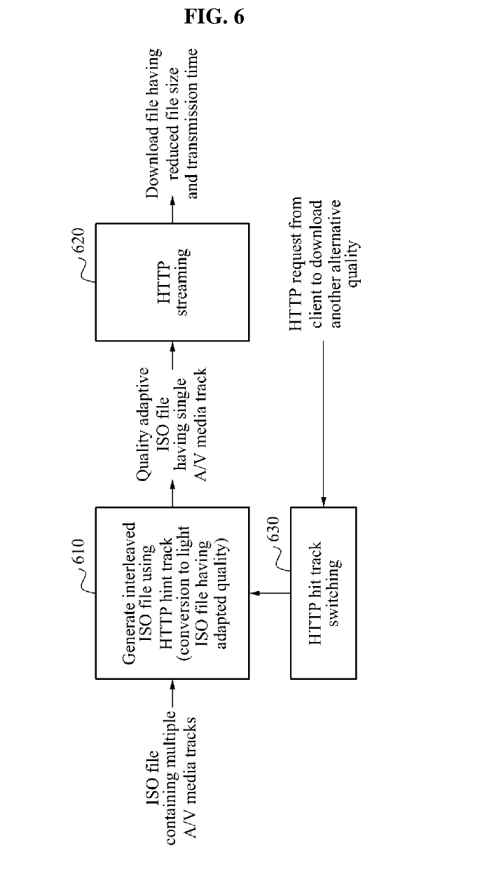

FIG. 6 is a block diagram illustrating a process of generating a quality adaptive ISO file using an HTTP hint track switching and a process of an HTTP streaming for the generated ISO file according to an embodiment of the present invention.

A quality adaptive HTTP streaming service may be provided when a switching between HTTP hint tracks is used.

A file to be converted may correspond to an ISO file having multiple A/V media tracks.

In operation 610, an ISO file interleaved using an HTTP hint track may be generated. That is, an ISO file having multiple A/V media tracks may be converted into a light ISO file having an adapted quality which is adaptive to a quality requested from a terminal.

A converted light ISO file may correspond to a quality adaptive file having a single A/V media track. In operation 620, an HTTP streaming service for the quality adaptive file having a single A/V media track may be provided.

Operation 620 may provide a file download having a reduced file size and transmission time.

Operation 630 may be performed when a request for an HTTP arrives from a client, that is, a terminal to download a file of an alternative quality. That is, operation 630 may be performed when the client, that is, the terminal requests a new quality during an HTTP streaming service.

In operation 630, an HTTP hint track switching may be performed. The HTTP hint track switching may correspond to a switching of an HTTP hint track for generating a light ISO file among multiple HTTP hint tracks in an ISO file having multiple A/V media tracks. By switching the HTTP hint track, a light ISO file satisfying a new quality requested from a terminal may be generated during the HTTP streaming service.

Through operation 630, the HTTP streaming service for a light ISO file satisfying the alternative quality may continue to be provided.

Through operations 610 through 630, a size of an ISO file transmitted by the HTTP streaming service may be reduced, a download time of an ISO file may be reduced, and an amount of traffic in an IP network such as the Internet may be reduced.

Embodiments of the present invention described with reference to FIG. 1 through FIG. 5 and technological content according to the embodiments may be applied to the present embodiment. Thus, further descriptions will be omitted for conciseness.

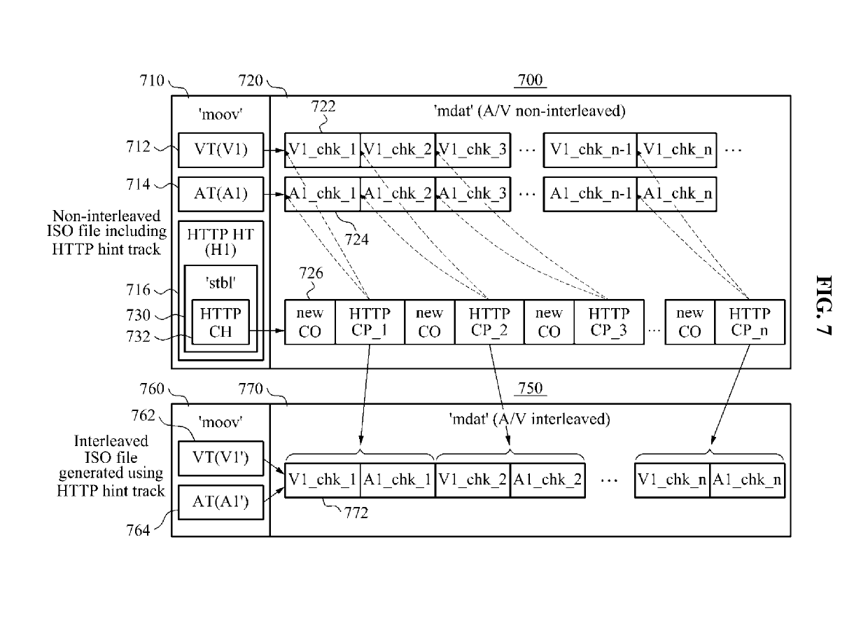

FIG. 7 is a diagram illustrating a scheme of converting an ISO file based on a non-interleaved storing scheme to an ISO file based on an interleaved storing scheme using an HTTP hint track according to an embodiment of the present invention.

An original file 700 may include a ‘moov’ 710 and an ‘mdat’ 720.

The ‘moov’ 710 may include a video track (video trak; VT(V1)) 712, an audio track (audio trak; AT(A1)) 714, and an HTTP hint track (hint trak; HT(H1)) 716.

The video track 712 may refer to n video chunks 722.

The audio track 714 may refer to n audio chunks 724.

The HTTP hint track 716 may include a sample table box (‘stbl’) 730.

The stbl 730 may include information associated with a temporal data position and a spatial data position of HTTP hint samples 726 stored in the ‘mdat’ 720.

That is, the ‘stbl’ 730 or the HTTP hint track 716 may refer to the HTTP hint samples 726.

To refer to the HTTP hint samples 726, the ‘stbl’ 730 may include an HTTP chunk hint (CH) 732 pointed to by the HTTP hint samples 726.

The ‘mdat’ 720 may include the n video chunks 722. The n video chunks 722 may include V1_chk_1 through V1_chk_n. V1_chk_1 may correspond to a first video chunk and V1_chk_n may correspond to an n^{th} video chunk.

The mdat 720 may include the n audio chunks 724. The n audio chunks 724 may include A1_chk_1 through A1_chk_n. A1_chk_1 may correspond to a first audio chunk and A1_chk_n may correspond to an n^{th} audio chunk.

The ‘mdat’ 720 may successively include the n video chunks 722 and the n audio chunks 724. Thus, the ‘mdat’ 720 may be A/V non-interleaved, and the original file 700 may correspond to a non-interleaved ISO file including an HTTP hint track.

The ‘mdat’ 720 may include n HTTP hint samples 726. An HTTP hint sample may include a chunk offset (CO) and an HTTP chunk pointer (CP). Each of at least one HTTP hint sample 726 may include HTTP chunk pointer_1 (HTTP CP_1) through HTTP chunk pointer_n (HTTP CP_N). According to an order, HTTP chunk pointer_1 may correspond to a first HTTP chunk pointer, and HTTP chunk pointer_n may correspond to an n^{th} HTTP chunk pointer.

A video chunk and an audio chunk pair is a basic data unit handled by an HTTP hint track. For example, an i^{th} HTTP chunk pointer may indicate an i^{th} video chunk and an i^{th} audio chunk (1≦i≦n).

A terminal provided with an HTTP streaming service may play back a minimum of a single pair of A/V chunks. The single pair of A/V chunks may correspond to chunks for the same time duration. That is, the single pair of A/V chunks may correspond to a data unit for a playback. Hereinafter, the single pair of A/V chunks will be denoted by an HTTP chunk.

As necessary, the HTTP chunk may include video chunks of each of at least one video. The HTTP chunk may include video chunks of each of at least one audio.

The single pair of A/V chunks included in the same time duration may be referred to by the HTTP CP.

An interleaved ISO file 750 based on the original file 700 may be generated using the HTTP hint track 716.

The interleaved ISO file 750 may include a ‘moov’ 760 and an ‘mdat’ 770.

An HTTP chunk may include a video chunk and an audio chunk. An i^{th} video chunk included in an i^{th} HTTP chunk may correspond to V1_chk_i of the original file 700. An i^{th} audio chunk included in the i^{th} HTTP chunk may correspond to A1_chk_i of the original file 700.

The ‘moov’ 760 may include a video track 762 and an audio track 764. Each of the video track 762 and the audio track 764 may refer to HTTP chunks 772. A basic operation principle for generating the interleaved ISO file 750 is to identify (or read) a pair of A/V chunks included in the same time duration using the HTTP hint track 716, and to store the identified pair of A/V chunks in an interleaved scheme.

To identify the pair of A/V chunks, an HTTP chunk pointer indicating position information of a video chunk and an audio chunk to be read from the video track 712 and the audio track 714 may be included in the ‘mdat’ 720 of the HTTP hint track 716.

To expedite a process of generating a new ‘moov’ 760 for the interleaved ISO file 750, a chunk offset value stored in a chunk offset box (or an ‘stco’ box) of an A/V track recorded in the moov 710 of the original file 700 may be changed. A new chunk offset corresponding to a new chunk offset value used for the interleaved ISO file 750 may be included in the ‘mdat’ 720.

The video track 712 and the audio track 714 of the original ISO file 700 are denoted by V1 and A1, respectively. Whereas, the video track 762 and the audio track 764 of the interleaved ISO file 750 are denoted by V1′ and A1′, respectively. The change of notation may be due to a change of chunk offset information of the original video track 712 and audio track 714 by new chunk offset information in a process of converting a file based on an HTTP hint track.

The HTTP hint track 716 may not be included in a converted ISO file 750 that is converted in an interleaved storing scheme for an HTTP streaming service. Thus, the HTTP hint track 716 may be removed from the ‘mdat’ 770.

Embodiments of the present invention described with reference to FIG. 1 through FIG. 6 and technological content according to the embodiments may be applied to the present embodiment. Thus, further descriptions will be omitted for conciseness.

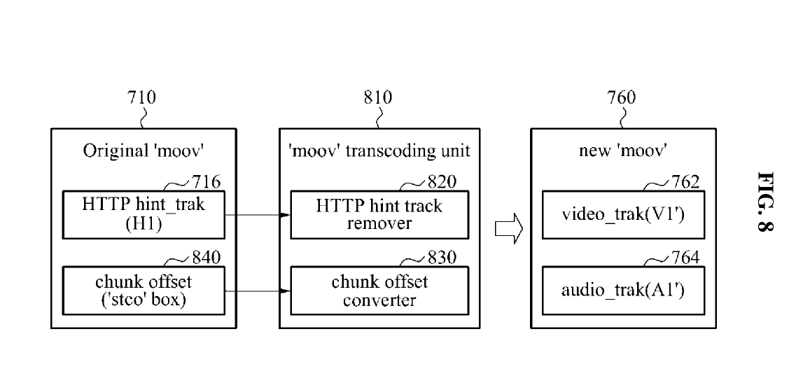

FIG. 8 is a diagram illustrating a scheme of generating a ‘moov’ 760 through a transcoding process that includes deleting an HTTP hint track 716 and changing a chunk offset value according to an embodiment of the present invention.

A transcoding unit 810 may include an HTTP hint track remover 820 and a chunk offset converter 830.

The HTTP hint track remover 820 may remove the HTTP hint track 716 from a ‘moov’ 710 in the original file 700 previously described with reference to FIG. 7.

The chunk offset converter 830 may calculate new chunk offsets for chunk offsets of the original file 700. Here, the chunk offsets may be stored in a chunk offset box (or an ‘stco’ box) 840 of an A/V track that is recorded in the ‘moov’ 710 of the original file 700.

The ‘moov’ 760 of the ISO file 750 interleaved by the HTTP hint track remover 820 and the chunk offset converter 830 may be generated. As described in the foregoing, the ‘moov’ 760 of the ISO file 750 may include a video track 762 and an audio track 764.

All operations of the schemes described with reference to FIG. 7 and FIG. 8 may be performed based on media chunks composed of multiple samples instead of a single sample. Thus, complexity of the operations may be relatively low.

In general, a video chunk may be constructed by bundling samples corresponding to several seconds. In general, a single chunk may be constructed by bundling multiple groups of picture.

Embodiments of the present invention described with reference to FIG. 1 through FIG. 7 and technological content according to the embodiments may be applied to the present embodiment. Thus, further descriptions will be omitted for conciseness.

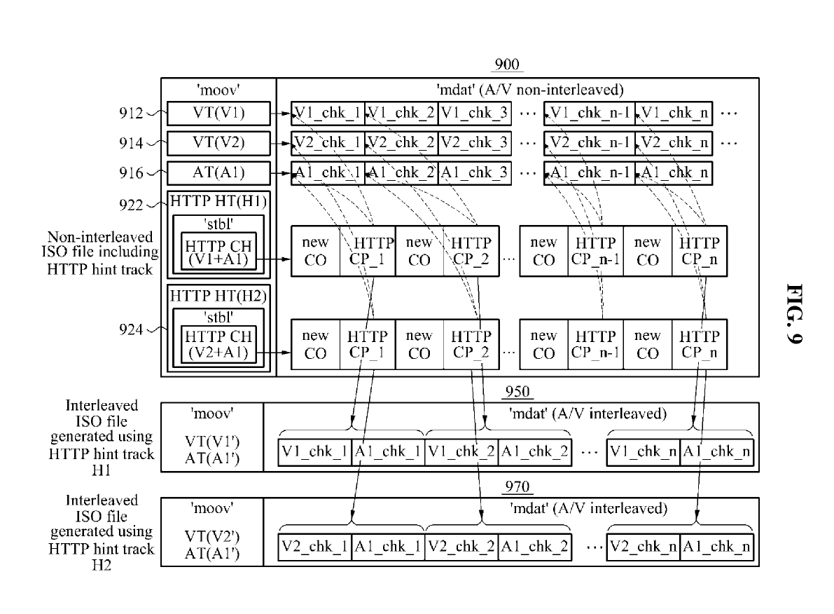

FIG. 9 is a diagram illustrating a scheme of converting an ISO file based on a non-interleaved storing scheme into an ISO file based on an interleaved storing scheme using multiple HTTP hint tracks according to an embodiment of the present invention.

An original file 900 may be similar to the original file 700 of FIG. 7. However, the original file 900 may include multiple media tracks VT(V1) 912, VT(V2) 914, and AT(A1) 916. The multiple media tracks VT(V1) 912, VT(V2) 914, and AT(A1) 916 may be used for supporting multiple bitrates and resolutions for content indicated by the original file 900.

The original file 900 may correspond to an ISO file that stores two video tracks VT(V1) 912, VT(V2) 914, and a single audio track AT(A1) 916 in a non-interleaved scheme to support two types of video bitrates.

For a file having such configuration, an HTTP streaming service selectively providing two types of video qualities may be provided by utilizing the video tracks VT(V1) 912 and VT(V2) 914 having different bitrates.

The original file 900 may include two HTTP hint tracks HT(H1) 922 and HT(H2) 924 to effectively perform the HTTP streaming service while selectively providing two types of video tracks.

The HTTP hint track HT(H1) 922 may be used for performing an HTTP streaming using the video track VT(V1) 912 and the audio track AT(A1) 916, and the HTTP hint track HT(H2) 924 may be used for performing an HTTP streaming using the video track VT(V2) 914 and the audio track AT(A1) 916.

Using two HTTP hint tracks HT(H1) 922 and HT(H2) 924, two interleaved ISO files 950 and 970 may be generated. The two interleaved ISO files 950 and 970 may have different qualities.

The HTTP hint track HT(H1) 92 may copy a single pair of A/V chunks constructing an HTTP chunk from the video track VT(V1) 912 and the audio track to AT(A1) 916, respectively. Likewise, the HTTP hint track HT(H2) 924 may copy a single pair of A/V chunks constructing an HTTP chunk from the video track VT(V2) 914 and the audio track AT(A1) 916, respectively.

The HTTP hint tracks HT(H1) 922 and HT(H2) 924 of a number of types of multimedia qualities supported by an ISO file including multiple media tracks may be included in the original file 900, and an HTTP streaming service having multiple qualities may be provided by the HTTP hint tracks HT(H1) 922 and HT(H2) 924.

Information of an average bitrate and a maximum bitrate supported by each of the HTTP hint tracks HT(H1) 922 and HT(H2) 924 may be indicated by ‘avgbitrate’ and ‘maxbitrate’ fields of a hint media header (hmhd) box. Thus, the HTTP hint tracks HT(H1) 922 and HT(H2) 924 capable of providing a predetermined quality may be provided based on information of the ‘avgbitrate’ and ‘maxbitrate’ fields of the hmhd box, and an HTTP streaming according to the selected HTTP hint tracks HT(H1) 922 and HT(H2) 924 may be performed.

Embodiments of the present invention described with reference to FIG. 1 through FIG. 8 and technological content according to the embodiments may be applied to the present embodiment. Thus, further descriptions will be omitted for conciseness.

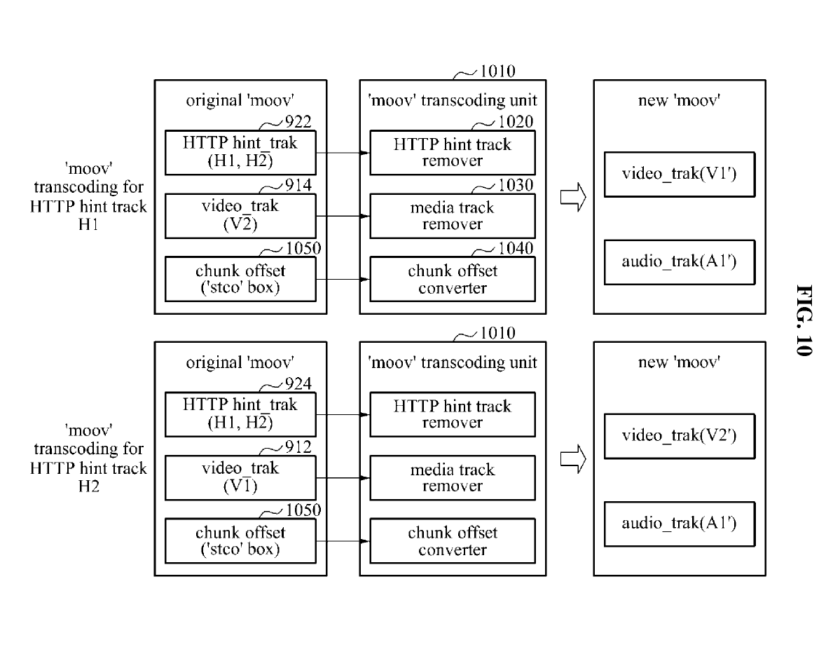

FIG. 10 is a diagram illustrating a scheme of generating a plurality of ‘moov’s through a transcoding process for an original file 900 that includes multiple HTTP hint tracks according to an embodiment of the present invention.

A scheme of generating a moov of a first interleaved ISO file 950 is illustrated at the top of FIG. 10. A scheme of generating a moov of a second interleaved ISO file 970 is illustrated at the bottom of FIG. 10.

A transcoding unit 1010 may include an HTTP hint track remover 1020, a media track remover 1030, and a chunk offset converter 1040.

Descriptions for the transcoding unit 810 of FIG. 8 may be applied to the transcoding unit 1010. As such, similar descriptions will be omitted for brevity.

The HTTP hint track remover 1020 may be similar to the HTTP hint track remover 820 of FIG. 8. The HTTP hint track remover 1020 may remove a plurality of HTTP hit tracks 922 and 924 in the original file 900.

The HTTP hint track remover 1020 may remove a track 914 or 912 not to be used in an interleaved ISO file 950 or 970 that is to be generated, among multiple media tracks 912, 914, and 916.

The chunk offset converter 1040 may be similar to the chunk offset converter 830 of FIG. 8. The chunk offset converter 1040 may calculate new chunk offsets for tracks 914 and 916, or 912 and 916 to be used in the interleaved ISO file 950 or 970 that is to be generated among multiple media tracks 912, 914, and 916. The chunk offsets may be stored in a chunk offset box (or an ‘stco’ box) 1050 of an A/V track recorded in a ‘moov’ of the original file 900. A separate chunk offset box may be used for each of the multiple media tracks 912, 914, and 916.

Accordingly, the original file 900 may be converted into the interleaved ISO file 950 or 970 through a removal of an HTTP hint track, a removal of an unused media track, and a change of a chunk offset value.

Embodiments of the present invention described with reference to FIG. 1 through FIG. 9 and technological content according to the embodiments may be applied to the present embodiment. Thus, further descriptions will be omitted for conciseness.

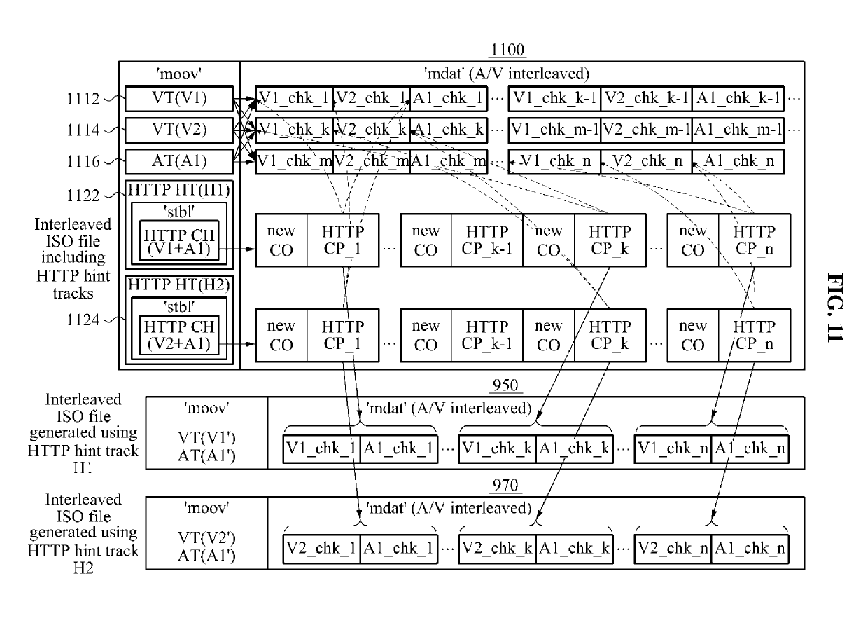

FIG. 11 is a diagram illustrating a scheme of converting an ISO file based on an interleaved storing scheme into a light ISO file based on an interleaved storing scheme using multiple HTTP hint tracks according to an embodiment of the present invention.

A scheme for a conversion to an ISO file based on an interleaved storing scheme using an HTTP hint track described with reference to FIG. 7 and FIG. 8 may be applied to an ISO file in which an original file 1100 is stored in an interleaved scheme.

Referring to FIG. 11, a first video track 1112, a second video track 1114, and an audio track 1116 may be interleaved. That is, video chunks of the first video track 1112, video chunks of the second video track 1114, and audio chunks of the audio track 1116 may be interleaved and stored.

HTTP chunk pointers of a first HTTP hint track 1122 may indicate interleaved first video chunk and audio chunk. HTTP chunk pointers of a second HTTP hint track 1124 may indicate an interleaved second video chunk and audio chunk.

Thus, a pair of A/V chunks constructing an HTTP chunk may be identified by an HTTP chunk pointer, independent from interleaved tracks 1112, 1114, and 1116.

Accordingly, a converting scheme described with reference to FIG. 9 may be applied to the original file 1100 based on the interleaved storing scheme, and the aforementioned interleaved ISO files 950 and 970 may be generated.

Embodiments of the present invention described with reference to FIG. 1 through FIG. 10 and technological content according to the embodiments may be applied to the present embodiment. Thus, further descriptions will be omitted for conciseness.

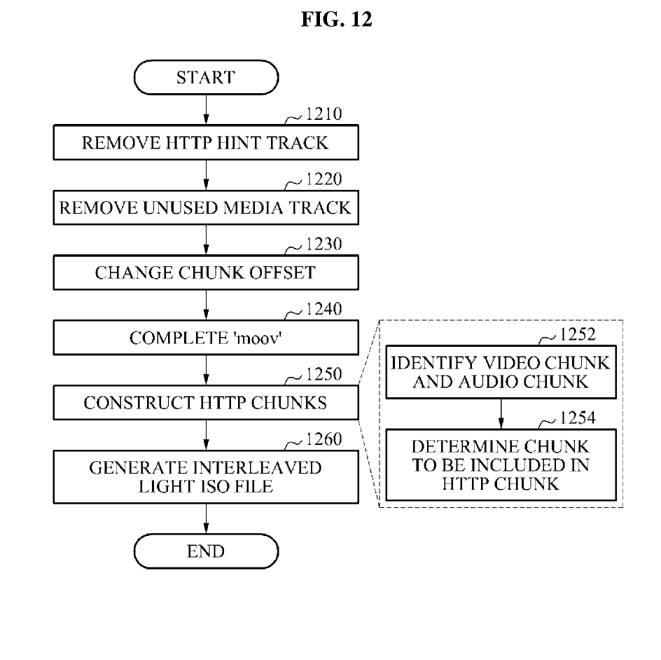

FIG. 12 is a flowchart illustrating a scheme of generating a light ISO file based on an interleaved storing scheme according to an embodiment of the present invention.

An original file may be used to generate the light ISO file. The original file may correspond to the original files 700, 900, and 1100 of FIG. 7, FIG. 9, and FIG. 11, respectively. The original file may correspond to a non-interleaved ISO file and a multi-track ISO file. Here, the original file may include an HTTP hint track.

The light ISO file may be generated by modifying the original file. That is, the light ISO file may be generated by removing an HTTP hint track and an unused media track from the original file, and changing a chunk offset.

The original file may include at least one first video chunk, at least one audio chunk, and at least one first HTTP chunk pointer.

In operation 1210, HTTP hint tracks in the original file may be removed.

By removing a first HTTP hint track, a first HTTP chunk pointer referred to by the first HTTP hint track may be removed.

In operation 1220, unused media track in the original file may be removed.

Operation 1220 may be selectively performed when the original file corresponds to a multi-track ISO file.

In operation 1230, a chunk offset may be changed. The change of the chunk offset may indicate that a first chunk offset is calculated. The first chunk offset may indicate a new chunk offset described with reference to FIG. 7. That is, an n^{th} first chunk offset indicating a position of an n^{th} first HTTP chunk in a first light ISO file may be calculated.

In operation 1240, a ‘moov’ for the light ISO file may be completed.

In operation 1250, HTTP chunks may be constructed using an HTTP hint track.

Operation 1250 may include the following operations.

In operation 1252, an n^{th} first video chunk among first video chunks and an n^{th} first audio chunk among first audio chunks may be identified. Here, the first video chunks and the first audio chunks may be pointed to by an n^{th} first HTTP chunk pointer among first HTTP chunk pointers, and n may be greater than or equal to 1 and less than or equal to a number of the first video chunks.

In operation 1254, the n^{th} first video chunk and the n^{th} first audio chunk may be determined as chunks to be included in an n^{th} first HTTP chunk among first HTTP chunks.

In operation 1260, a first light ISO file successively including the first HTTP chunks may be generated.

An operation of generating the first light ISO file may correspond to arranging the n^{th} first HTTP chunk in the first light ISO file using the n^{th} first chunk offset.

The first light ISO file may correspond to an interleaved file. That is, at least one first video chunk and at least one first audio chunk may be successively arranged in the first light ISO file in an interleaved scheme.

The first light ISO file may correspond to the aforementioned interleaved ISO file 750, 950, or 970.

When the original file corresponds to a multimedia track ISO file, the original file may include second video chunks. A first video indicated by the first video chunks and a second video indicated by the second video chunks may have different qualities, for example, bitrates or resolutions.

When a predetermined quality is required for the first light ISO file, the first video may correspond to a video having a quality corresponding to a quality that is required for the first light ISO file.

When the first light ISO file is generated, the second video chunks unused for generating the first light ISO file may be removed from the original file in operation 1220.

The aforementioned scheme of generating a light ISO file based on an interleaved storing scheme may be used to generate a second light ISO file together with the first light ISO file at the same time or successively.

In this instance, in operation 1252, an n^{th} second video chunk among second video chunks and an n^{th} first audio chunk among first audio chunks may be identified. Here, the second video chunks and the first audio chunks may be pointed to by an n^{th} second HTTP chunk pointer among second HTTP chunk pointers.

In operation 1254, the n^{th} second video chunk and the n^{th} second audio chunk may be determined as chunks to be included in an n^{th} second HTTP chunk among second HTTP chunks.

In operation 1260, a second light ISO file successively including the second HTTP chunks may be generated. At least one second video chunk and at least one second audio chunk may be successively arranged in the second light ISO file in an interleaved scheme.

Embodiments of the present invention described with reference to FIG. 1 through FIG. 11 and technological content according to the embodiments may be applied to the present embodiment. Thus, further descriptions will be omitted for conciseness.

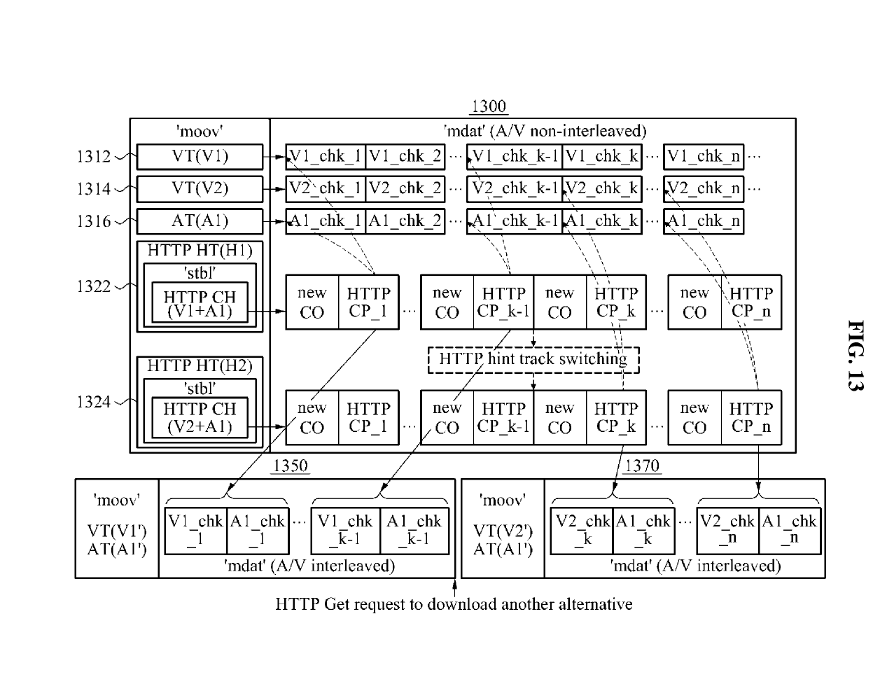

FIG. 13 is a diagram illustrating a scheme of generating an interleaved ISO file for a quality adaptive HTTP streaming service according to an embodiment of the present invention.

The interleaved ISO file may correspond to a multimedia file provided by a streaming service. Thus, the present embodiment may describe a scheme of generating a multimedia file for a streaming service.

When a first interleaved ISO file 1350 is generated by an HTTP HT (H1) 1322, a server may provide the generated first interleaved ISO file 1350 to a terminal through an HTTP streaming service.

The first interleaved ISO file 1350 may be generated by a first video track 1312 and a first audio track 1316 referred to by an HTTP chunk pointer of the HTTP HT (H1) 1322.

While the HTTP streaming service is performed, the terminal may request the server for a change of a quality of content provided by the HTTP streaming service. The changed quality may be provided by an HTTP HT (H2) 1324. That is, the changed quality may be provided by a second video track 1314 and the first audio track 1316 referred to by an HTTP chunk pointer of the HTTP HT (H2) 1324.

Thus, the server may generate a second interleaved ISO file 1370 using the HTTP HT (H2) 1324, and provide a quality adaptive HTTP streaming service by transmitting, to the terminal, the generated second interleaved ISO file 1370 through the HTTP streaming service.

When the HTTP streaming service is provided, the server may successively transmit, to the terminal, a part of the generated first interleaved ISO file 1350, that is, HTTP chunks while generating the first interleaved ISO file 1350.

When the terminal requests a change of a quality of content while the server generates the first interleaved ISO file 1350, the server may generate the second interleaved ISO file 1370 conforming to the changed quality by switching an HTTP hint track for generating an interleaved ISO file, that is, by switching the HTTP hint track for generating an interleaved ISO file from the HTTP HT (H1) 1322 to the HTTP HT (H2) 1324.

The quality adaptive HTTP streaming service by the switching of the HTTP hint track may be performed using a track selection (tsel) box of a standard ISO file format. The HTTP HT (H1) 1322 and the HTTP HT (H2) 1324 may be set as a single switching group by the tsel box. A quality provided by the HTTP HT (H1) 1322 and the HTTP HT (H2) 1324 may be provided to the server through attribute information.

The server may provide the quality adaptive HTTP streaming service through a switch between the HTTP HT (H1) 1322 and the HTTP HT (H2) 1324 that provide various qualities based on the information.

Referring to FIG. 13, the first to k−1^{th} HTTP chunks are transmitted to the terminal by the HTTP HT (H1) 1322. The first interleaved ISO file 1350 may include all HTTP chunks, that is, n HTTP chunks, and may include only the first to k−1^{th} HTTP chunks.

From a k^{th} HTTP chunk, HTTP chunks generated by the HTTP HT (H2) 1324 due to a request for a change of quality may be transmitted to the terminal by the HTTP streaming service.

The request for a change of quality may be transmitted from the terminal to the server through an HTTP Get request that is for downloading an alternative.

The second interleaved ISO file 1370 may include a k^{th} HTTP chunk through an n^{th} HTTP chunk.

To switch the HTTP hint track with chunk accuracy, an original file 1300 may be generated so that a first sample included in chunks of a video track may correspond to an I-frame.

In general, a video chunk may be constructed by bundling a plurality of groups of picture corresponding to several seconds. Thus, the first sample of the video chunk may start from the I-frame.

Embodiments of the present invention described with reference to FIG. 1 through FIG. 12 and technological content according to the embodiments may be applied to the present embodiment. Thus, further descriptions will be omitted for conciseness.

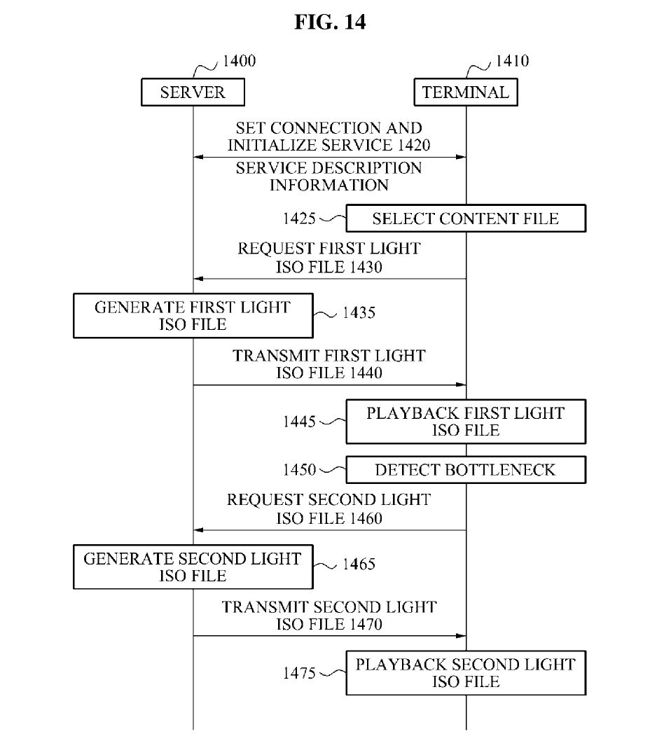

FIG. 14 is a flowchart illustrating a method for a quality adaptive HTTP streaming service according to an embodiment of the present invention.

Operations 1420 through 1475 described in the following may correspond to a method for transmitting a streaming service performed by a server 1400 and a method for receiving the streaming service performed by a terminal 1410.

In operation 1420, a connection between the server 1400 and the terminal, that is, a client 1410 may be set, and a service may be initialized. The server 1400 may transmit a service description information to the terminal 1410.

In operation 1425, the terminal 1410 may select a content file to be transmitted and a first quality of the content file. The content file to be transmitted may correspond to a first light ISO file. The first light ISO file may correspond to a file having the selected first quality.

The terminal 1400 may generate first quality information indicating a quality of the first light ISO file.

In operation 1430, the terminal 1410 may request the server 1400 for the first light ISO file. The request may correspond to an HTTP GET request.

The request for the first light ISO file may include the first quality information of the first light ISO file.

The server 1400 may receive, from the terminal 1410, the request for the first light ISO file.

In operation 1435, the server 1400 may generate the first light ISO file based on an original file. The first light ISO file may correspond to the aforementioned interleaved ISO file 950 or 1350. That is, the first light ISO file may correspond to a light ISO file generated using an HTTP hint track.

An operation for generating the first light ISO file is described in the foregoing with reference to FIG. 12.

The first light ISO file may include at least one first video chunk and at least one first audio chunk, and the at least one first video chunk and the at least one first audio chunk in the first light ISO file may be interleaved. The at least one first video chunk may be a chunk of a video corresponding to the first quality information and the at least one audio chunk may be a chunk of an audio corresponding to the first quality information.

In operation 1440, the server 1400 may transmit the first ISO file to the terminal 1410.

The server 1400 may transmit the first ISO file to the terminal 1410 through an HTTP stream.

The terminal 1410 may receive the first ISO file from the server 1400 through a stream.

In operation 1445, the terminal 1410 may play back the first light ISO file. The terminal 1410 may play back a transmitted part of the first light ISO file while being provided with the first light ISO file from the server 1400 through an HTTP stream.

In operation 1450, the terminal 1410 may detect a bottleneck. In response to the bottleneck being detected, the terminal 1410 may select another alternative quality. That is, the terminal 1410 may select a second quality of the content file based on the detected bottleneck. The content file to be transmitted may correspond to a second light ISO file. The second ISO file may correspond to a file having the selected second quality.

The terminal 1400 may generate second quality information indicating a quality of the second light ISO file.

In operation 1460, the terminal 1410 may request the server 1400 for the second light ISO file. The request may correspond to an HTTP GET request.

The request for the second light ISO file may include the second quality information of the second light ISO file.

In operation 1465, the server 1400 may generate the second light ISO file based on an original file. The second light ISO file may correspond to the aforementioned interleaved ISO file 970 or 1370. That is, the second light ISO file may correspond to a light ISO file generated using an HTTP hint track.

An operation for generating the second light ISO file is described in the foregoing with reference to FIG. 12 and FIG. 13.

The second light ISO file may include at least one second video chunk and at least one first audio chunk, and the at least one second video chunk and the at least one first audio chunk in the second light ISO file may be interleaved. The at least one second video chunk may be a chunk of a video corresponding to the second quality information, and the at least one audio chunk may be a chunk of an audio corresponding to the second quality information.

The at least one first video chunk and the at least one second video chunk may correspond to chunks of videos having the same content, that is, the same content and having different qualities.

The at least one second video chunk may refer to video chunks corresponding to non-transmitted first video chunks that are not transmitted to the terminal 1410 by a streaming service of the first light ISO file among the at least one first video chunk when the request for the second light ISO file is received by the server 1400.

The at least one second audio chunk may refer to audio chunks corresponding to non-transmitted first audio chunks that are not transmitted to the terminal 1410 by a streaming service of the first light ISO file among the at least one first audio chunk when the request for the second light ISO file is received by the server 1400.

In operation 1470, the server 1400 may transmit the second light ISO file to the terminal 1410.

The server 1400 may transmit the second light ISO file to the terminal 1410 through an HTTP stream.

The terminal 1410 may receive the second ISO file from the server 1400 through a stream.

In operation 1475, the terminal 1410 may play back the second light ISO file. The terminal 1410 may play back a transmitted part of the second light ISO file while being provided with the second light ISO file from the server 1400 through an HTTP stream.

The terminal 1410 may play back, from a predetermined position, a part of the first light ISO file that is played back in operation 1445 using the second light ISO file. That is, by successively playing back the first light ISO file and the second light ISO file, the content file selected in operation 1425 may be continually played back while a quality of the content file is switched.

By providing a light ISO file based on an interleaved storing scheme through an HTTP stream, the terminal 1410 may reduce time taking for downloading content. An amount of traffic in an IP network may be reduced.

Embodiments of the present invention described with reference to FIG. 1 through FIG. 13 and technological content according to the embodiments may be applied to the present embodiment. Thus, further descriptions will be omitted for conciseness.

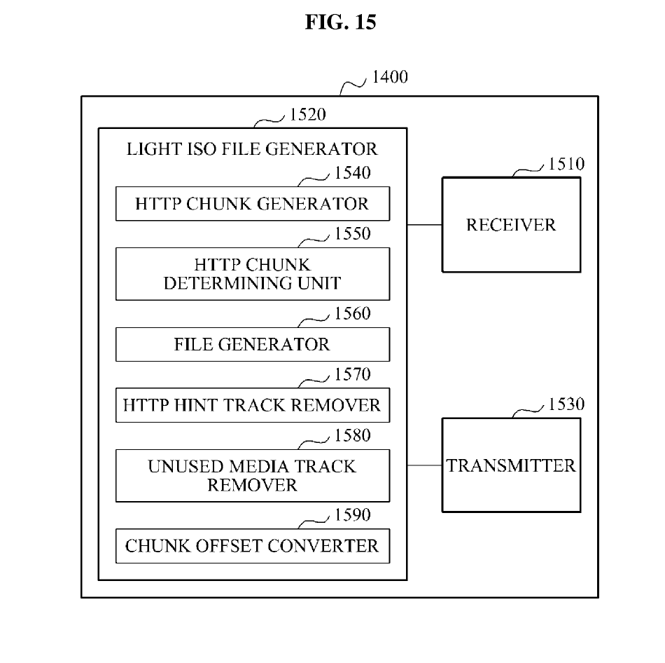

FIG. 15 is a diagram illustrating a configuration of a server according to an embodiment of the present invention.

A server 1400 may correspond to an apparatus for transmitting a streaming service that performs the method of transmitting a streaming service described in the foregoing with reference to FIG. 14. The server 1400 may generate a light ISO file. Thus, the server 1400 may correspond to an apparatus for generating a multimedia file for a streaming service.

The server 1400 may include a receiver 1510, a light ISO file generator 1520, and a transmitter 1530.

The receiver 1510 may receive information from the terminal 1410. For example, the receiver 1510 may receive, from the terminal 1410, information for setting a connection and initializing a service, a request a first light ISO file, and a request for a second light ISO file.

The transmitter 1530 may transmit information to the terminal 1410. For example, the transmitter 1530 may transmit, to the terminal 1410, information for setting a connection and initializing a service, a request a first light ISO file, and a request for a second light ISO file.

The light ISO file generator 1520 may generate the first light ISO file and the second light ISO file based on an original file.

The light ISO file generator 1520 may correspond to an apparatus for generating a light ISO file.

The light ISO file generator 1520 may generate the first light ISO file based on an interleaved storing scheme using an original file that includes at least one first video chunk, at least one first audio chunk, and at least one first HTTP chunk pointer. The light ISO file generator 1520 may generate the second light ISO file based on an interleaved storing scheme using an original file that includes at least one second video chunk, at least one first audio chunk, and at least one second HTTP chunk pointer.

The light ISO file generator 1520 may an HTTP chunk identifier 1540, an HTTP chunk determining unit 1550, and a file generator 1560.

The HTTP chunk identifier 1540 may perform operation 1252 described in the foregoing. For example, the HTTP chunk identifier 1540 may identify an n^{th} first video chunk among the at least one first video chunk and an n^{th} first audio chunk among the at least one first audio chunk. Here, the at least one first video chunk and the at least one first audio chunk may be pointed to by an n^{th} first HTTP chunk pointer among the at least one first HTTP chunk pointer. The HTTP chunk identifier 1540 may identify an n^{th} second video chunk among the at least one second video chunk and an n^{th} first audio chunk among the at least one first audio chunk. Here, the at least one second video chunk and the at least one first audio chunk may be pointed to by an n^{th} second HTTP chunk pointer among the at least one second HTTP chunk pointer.

The HTTP chunk determining unit 1550 may perform operation 1254 described in the foregoing. For example, the HTTP chunk determining unit 1550 may determine the n^{th} first video chunk and the n^{th} first audio chunk as chunks to be included in an n^{th} first HTTP chunk among first HTTP chunks. The HTTP chunk determining unit 1550 may determine the n^{th} second video chunk and the n^{th} first audio chunk as chunks to be included in an n^{th} second HTTP chunk among second HTTP chunks.

The file generator 1560 may perform operation 1260 described in the foregoing. For example, the file generator 1560 may generate a first light ISO file that successively includes the first HTTP chunks. The file generator 1560 may generate a second light ISO file that successively includes the second HTTP chunks.

The file generator 1560 may successively arrange the at least one first video chunk and the at least one first audio chunk in the first light ISO file in an interleaved scheme. The file generator 1560 may successively arrange the at least one second video chunk and the at least one first audio chunk in the second light ISO file in an interleaved scheme.

The light ISO file generator 1520 may further include an HTTP hint track remover 1570, an unused media track remover 1580, and a chunk offset converter 1590.

The HTTP hint track remover 1570 may perform operation 1210 described in the foregoing. The HTTP hint track remover 1570 may correspond to the HTTP hint track remover 820 or 1020.

The unused media track remover 1580 may perform operation 1220 described in the foregoing. The unused media track remover 1580 may correspond to the media track remover 1030.

The chunk offset converter 1590 may perform operation 1230 described in the foregoing. The chunk offset converter 1590 may correspond to the chunk offset converter 830 or 1040.

Embodiments of the present invention described with reference to FIG. 1 through FIG. 14 and technological content according to the embodiments may be applied to the present embodiment. Thus, further descriptions will be omitted for conciseness.

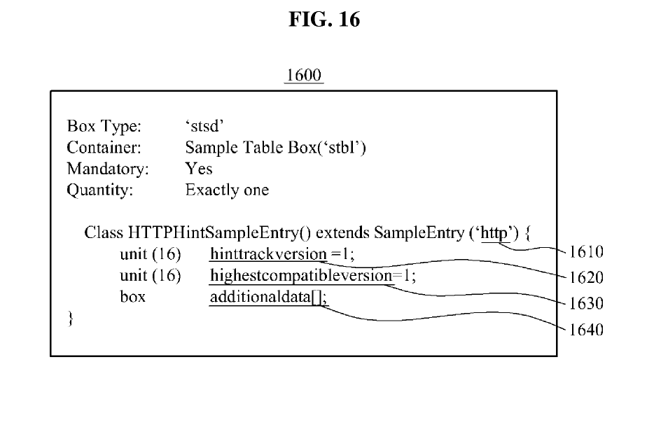

Hereinafter, a syntax and a semantic associated with an HTTP hint track format for storing an HTTP hint track in an ISO file format will be described with reference to FIG. 16 through FIG. 20.

FIG. 16 is a diagram illustrating a sample description box 1600 according to an embodiment of the present invention.

An ‘http’ 1610 may correspond to a sample entry name for the HTTP hint track.

A ‘hinttrackversion’ 1620 may correspond to a value set to “1,” and may indicate a current hint track version.

A “highestcompatibleversion” 1630 may correspond to a value set to “1,” and may indicate an oldest hint track version in which the current hint track supports a backward-compatibility.

An “additional data” 1640 may indicate a box expressed as FIG. 16.

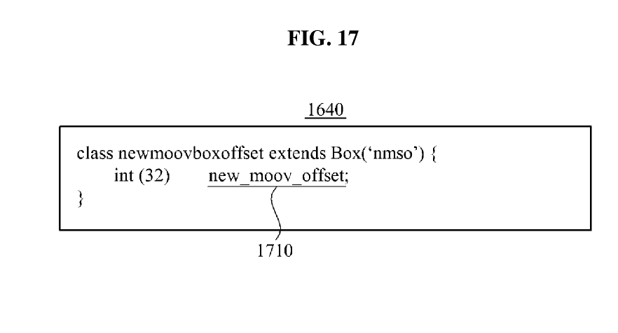

FIG. 17 is a diagram illustrating additional data 1640 according to an embodiment of the present invention.

A “new_moov_offset” 1610 may indicate a size of a ‘moov’ of an ISO file newly generated in an interleaved storing scheme. A “new_moov_offset” 1710 may be used as offset information of a size of a ‘moov’ to be considered when a value of a chunk offset of a media track is changed.

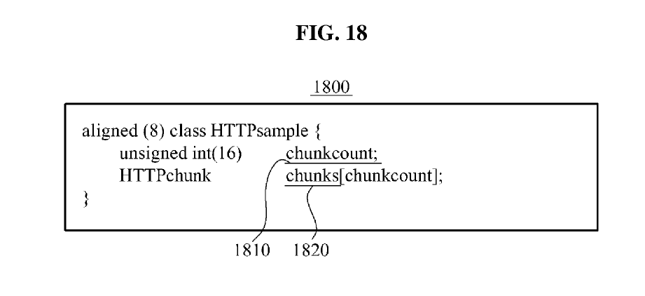

FIG. 18 is a diagram illustrating a sample format 1800 in an HTTP hint track according to an embodiment of the present invention.

A sample in an HTTP hint track may generate an HTTP chunk that bundles chunks stored in a plurality of media tracks.

A “chunkcount” 1810 may indicate a number of HTTP chunks to be generated.

A “chunks” 1820 may indicate generated HTTP chunks. The number of “chunks” 1820 to be generated may be indicated in the “chunkcount” 1810.

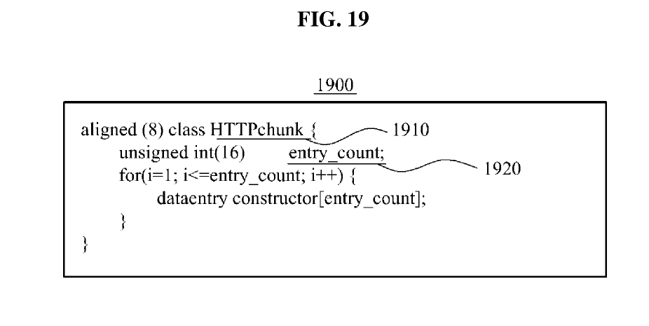

FIG. 19 is a diagram illustrating a packet entry format 1900 according to an embodiment of the present invention.

Each of HTTP chunks may be generated according to a configuration of an “HTTPchunk” 1910. An “entry_count” 1920 may indicate a number of items of a table following the “HTTPchunk” 1910.

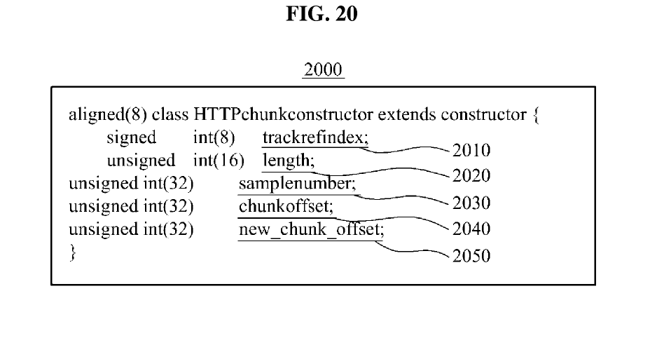

FIG. 20 is a diagram illustrating a constructor format 2000 according to an embodiment of the present invention.

A “trackrefindex” 2010 may indicate information of a media track to be referred to so as to obtain chunk data of a media by copying the chunk data.

A “length” 2020 may indicate, in a byte unit, a length of a media chunk to be copied and obtained.

A “samplenumber” 2030 may indicate a number of a sample located at a position of a starting point of a media chunk to be copied and obtained.

A “chunkoffset” 2040 may indicate, in a byte unit, a distance of a starting point of a media chunk to be copied and obtained from a starting point of a file.

A “new_chunk_offset” 2050 may indicate, in a byte unit, a distance of a copied and obtained chunk from a starting point of an ‘mdat’ when the copied and obtained chunk is stored in the mdat of an ISO file based on an interleaved storing scheme.

By calculating a sum of the “new_moov_offset” 1610 of FIG. 17 and a “new_chunk_offset” 2050, a new chunk offset value to be recorded in an ‘stco’ box of a media track included in an light ISO file in an interleaved storing scheme may be rapidly calculated.

The exemplary embodiments according to the present invention may be recorded in computer-readable media including program instructions to implement various operations embodied by a computer. The media may also include, alone or in combination with the program instructions, data files, data structures, and the like. to The media and program instructions may be those specially designed and constructed for the purposes of the present invention, or they may be of the well-known variety and available to those having skill in the computer software arts. Examples of computer-readable media include magnetic media such as hard disks, floppy disks, and magnetic tape; optical media such as CD ROM discs and DVD; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

It is to be understood that both the foregoing general description and the following detailed description are exemplary and explanatory and are intended to provide further explanation of the invention as claimed.

### EXPLANATION OF REFERENCE NUMERALS

1400 server
1410 terminal
1510 receiver
1520 light ISO file generator
1530 transmitter

1. A method of transmitting a streaming service, the method comprising:
receiving, from a terminal, a request for a first light International Organization for Standardization (ISO) file;
generating the first light ISO file based on an original file; and
transmitting, to the terminal, the first light ISO file through a stream,
wherein the first light ISO file includes at least one first video chunk and at least one first audio chunk, and
the at least one first video chunk and at least one first audio chunk included in the first light ISO file are interleaved.

2. The method of claim 1, wherein:
the request for the first light ISO file includes first quality information of the first light ISO file,
the at least one first video chunk refers to chunks of videos corresponding to the first quality information, and
the at least one first audio chunk refers to chunks of audios corresponding to the first quality information.

3. The method of claim 1, wherein the generating comprises:
identifying an n^{th} first video chunk among the at least one first video chunk and an n^{th} first audio chunk among the at least one first audio chunk, the at least one first video chunk and the at least one first audio chunk being pointed to by an n^{th} first Hypertext Transfer Protocol (HTTP) chunk pointer among first HTTP chunk pointers included in the original file, and n being greater than or equal to 1 and less than or equal to a number of the at least one first video chunk;
determining the n^{th} first video chunk and the n^{th} first audio chunk as chunks to be included in an n^{th} first HTTP chunk among first HTTP chunks; and
generating a first light ISO file that successively includes the first HTTP chunk, the at least one first video chunk and the at least one first audio chunk being successively arranged in the first light ISO file in an interleaved scheme.

4. The method of claim 3, wherein the generating further comprises:
calculating an n^{th} chunk offset that indicates a position of the n^{th} first HTTP chunk in the first light ISO file,
wherein the generating comprises arranging the n^{th} first HTTP chunk in the first light ISO file using the n^{th} chunk offset.

5. The method of claim 1, further comprising:
receiving, from the terminal, a request for a second light ISO file;
generating the second light ISO file based on the original file; and
transmitting, to the terminal, the second light ISO file through a stream,
wherein the second light ISO file includes at least one second video chunk and at least one second audio chunk, and
the at least one second video chunk and at least one second audio chunk included in the second light ISO file are interleaved.

6. The method of claim 5, wherein:
the at least one second video chunk refers to video chunks corresponding to non-transmitted first video chunks that are not transmitted to the terminal by a streaming service of the first light ISO file among the at least one first video chunk when the request for the second light ISO file is received, and
the at least one second audio chunk refers to audio chunks corresponding to non-transmitted first audio chunks that are not transmitted to the terminal by a streaming service of the first light ISO file among the at least one first audio chunk when the request for the second light ISO file is received.

7. The method of claim 5, wherein:
the request for the first light ISO file includes first quality information of the first light ISO file,
the request for the second light ISO file includes second quality information of the second light ISO file,
the at least one first video chunk refers to chunks of videos corresponding to the first quality information,
the at least one second video refers to chunks of videos corresponding to the second quality information,
the at least one first audio chunk refers to chunks of audios corresponding to the first quality information, and
the at least one second audio chunk refers to chunks of audios corresponding to the second quality information.

8. The method of claim 7, wherein the at least one video chunk and the at least one second video chunk correspond to chunks of videos having the same content and having different qualities.

9. The method of claim 5, wherein the generating of the second light ISO file comprises:
identifying an n^{th} second video chunk among the at least one second video chunk and an n^{th} second audio chunk among the at least one second audio chunk, the at least one second video chunk and the at least one second audio chunk being pointed to by an n^{th} second HTTP chunk pointer among second HTTP chunk pointers included in the original file, n being greater than or equal to m and less than or equal to a number of the at least one second video chunk, and m corresponding to an index of a primary first video chunk that is not transmitted to the terminal by a streaming service among the at least one first video chunk in the first light ISO file when the request for the second light ISO file is received;
determining the n^{th} second video chunk and the n^{th} second audio chunk as chunks to be included in an n^{th} second HTTP chunk among second HTTP chunks; and
generating the second light ISO file that successively includes the second HTTP chunks, the at least one second video chunk and the at least one second audio chunk being successively arranged in the second light ISO file in an interleaved scheme.

10. An apparatus for transmitting a streaming service, the apparatus comprising:
a receiver to receive, from a terminal, a request for a first light International Organization for Standardization (ISO) file;
a light ISO file generator to generate the first light ISO file based on an original file; and
a transmitter to transmit, to the terminal, the first light ISO file through a stream,
wherein the light ISO file generator includes, in the first light ISO file, at least one first video chunk and at least one first audio chunk to be interleaved.

11. A method of receiving a streaming service, the method comprising:
transmitting, to a server, a request for a first light International Organization for Standardization (ISO) file;
receiving, from the server, the first light ISO file generated based on an original file through a stream;
transmitting, to the server, a request for a second light ISO file; and
receiving, from the server, the second light ISO file generated based on the original file through a stream,
wherein the first light ISO file includes at least one first video chunk and at least one first audio chunk,
the second light ISO file includes at least one second video chunk and at least one second audio chunk,
the at least one first video chunk and at least one first audio chunk included in the first light ISO file are interleaved, and
the at least one second video chunk and at least one second audio chunk included in the second light ISO file are interleaved.

12. The method of claim 11, further comprising:
generating first quality information indicating a quality of the first light ISO file; and
generating second quality information indicating a quality of the second light ISO file,
wherein the request for the first light ISO file includes the first quality information,
the request for the second light ISO file includes the second quality information,
the at least one first video chunk refers to chunks of videos corresponding to the first quality information,
the at least one second video chunk refers to chunks of videos corresponding to the second quality information,
the at least one first audio chunk refers to chunks of audios corresponding to the first quality information, and
the at least one second audio chunk refers to chunks of audios corresponding to the second quality information.

13. An apparatus for receiving a streaming service, the apparatus comprising:
transmitting, to a server, a request for a first light International Organization for Standardization (ISO) file;
receiving, from the server, the first light ISO file generated based on an original file through a stream;
transmitting, to the server, a request for a second light ISO file; and
receiving, from the server, the second light ISO file generated based on the original file through a stream,
wherein the first light ISO file includes at least one first video chunk and at least one first audio chunk,
the second light ISO file includes at least one second video chunk and at least one second audio chunk,
the at least one first video chunk and at least one first audio chunk included in the first light ISO file are interleaved, and
the at least one second video chunk and at least one second audio chunk included in the second light ISO file are interleaved.

14. The apparatus of claim 11, further comprising:
generating first quality information indicating a quality of the first light ISO file; and
generating second quality information indicating a quality of the second light ISO file,
wherein the request for the first light ISO file includes the first quality information,
the request for the second light ISO file includes the second quality information,
the at least one first video chunk refers to chunks of videos corresponding to the first quality information,
the at least one second video chunk refers to chunks of videos corresponding to the second quality information,
the at least one first audio chunk refers to chunks of audios corresponding to the first quality information, and
the at least one second audio chunk refers to chunks of audios corresponding to the second quality information.

15. A method of generating a multimedia file for a streaming service using an original file that includes at least one first video chunk, at least one first audio chunk, and at least one first Hypertext Transfer Protocol (HTTP) chunk pointer, the method comprising:
identifying an n^{th} first video chunk among the at least one first video chunk and an n^{th} first audio chunk among the at least one first audio chunk, the at least one first video chunk and the at least one first audio chunk being pointed to by an n^{th} first HTTP chunk pointer among the at least one first HTTP chunk pointer, and n being greater than or equal to 1 and less than or equal to a number of the at least one first video chunk;
determining the n^{th} first video chunk and the n^{th} first audio chunk as chunks to be included in an n^{th} first HTTP chunk among first HTTP chunks; and
generating a first light ISO file that successively includes the first HTTP chunks, the at least one first video chunk and the at least one first audio chunk being successively arranged in the first light ISO file in an interleaved scheme.

16. The method of claim 15, further comprising:
calculating an n^{th} first chunk offset that indicates a position of the n^{th} first HTTP chunk in the first light ISO file,
wherein the generating comprises arranging the n^{th} first HTTP chunk in the first light ISO file using the n^{th} first chunk offset.

17. The method of claim 15, further comprising:
removing the at least one first HTTP chunk pointer from the original file,
wherein the first light ISO file is generated by modifying the original file.

18. The method of claim 15, wherein:
the first light ISO file includes a ‘moov’ box and an ‘mdat’ box,
the ‘mdat’ box includes the first HTTP chunks,
the ‘moov’ box includes a first video track and a first audio track, and
the first video track and the first audio track refer to the first HTTP chunks.

19. The method of claim 15, wherein:
the original file includes a ‘moov’ box and an ‘mdat’ box,
the ‘mdat’ box includes the at least one first video chunk and the at least one first audio chunk,
the ‘moov’ box includes a first video track, a first audio track, and a first HTTP hint track,
the first video track refers to the at least one first video chunk,
the first audio track refers to the at least one first audio chunk, and
the first HTTP hint track refers to chunk offsets.

20. The method of claim 15, wherein:
the original file includes at least one second video chunk,
a first video indicated by the at least one first video chunk and a second video indicated by the at least one second video chunk have different qualities, and
the first video has a quality corresponding to a quality requested for the first light ISO file.

21. The method of claim 20, further comprising:
removing the at least one second video chunk from the original file,
wherein the first light ISO file is generated by modifying the original file.

22. The method of claim 20, further comprising:
identifying an n^{th} second video chunk among the at least one second video chunk and an n^{th} second audio chunk among the at least one second audio chunk, the at least one second video chunk and the at least one second audio chunk being pointed to by an n^{th} second HTTP chunk pointer among second HTTP chunk pointers, and n being greater than or equal to 1 and less than or equal to a number of the at least one first video chunk;
determining the n^{th} second video chunk and the n^{th} second audio chunk as chunks to be included in an n^{th} second HTTP chunk among second HTTP chunks; and
generating the second light ISO file that successively includes the second HTTP chunks, the at least one second video chunk and the at least one second audio chunk being successively arranged in the second light ISO file in an interleaved scheme,
wherein the original file includes the second HTTP chunk pointers.

23. An apparatus for generating a multimedia file for a streaming service using an original file that includes at least one first video chunk, at least one first audio chunk, and at least one first Hypertext Transfer Protocol (HTTP) chunk pointer, the method comprising:
an HTTP chunk identifier to identify an n^{th} first video chunk among the at least one first video chunk and an n^{th} first audio chunk among the at least one first audio chunk, the at least one first video chunk and the at least one first audio chunk being pointed to by an n^{th} first HTTP chunk pointer among the at least one first HTTP chunk pointer, and n being greater than or equal to 1 and less than or equal to a number of the at least one first video chunk;
an HTTP chunk determining unit to determine the n^{th} first video chunk and the n^{th} first audio chunk as chunks to be included in an n^{th} first HTTP chunk among first HTTP chunks; and
a file generator to generate a first light ISO file that successively includes the first HTTP chunks,
wherein the file generator successively arranges the at least one first video chunk and the at least one first audio chunk in the first light ISO file in an interleaved scheme.
